(19) United States
(12) Patent Application Publication
(10) Pub. No.: US 2018/0081460 A1
(43) Pub. Date: Mar. 22, 2018

(54) SCREEN TO PROTECT DISPLAY FROM LASER BEAM DAMAGE

(71) Applicant: John B. Lee, Ridgefield, CT (US)

(72) Inventor: John B. Lee, Ridgefield, CT (US)

(21) Appl. No.: 15/413,663

(22) Filed: Jan. 24, 2017

Related U.S. Application Data
(60) Provisional application No. 62/396,413, filed on Sep. 19, 2016.

(51) Int. Cl. G06F 3/041; H04M 1/02; H04B 1/3888

(52) U.S. Cl. CPC G06F 3/041; G06F 2203/04107; H04B 1/3888; H04M 1/0266

(57) ABSTRACT

Some embodiments are directed to a flat screen, such a display associated with a computer monitor or smartphone, having a display side and a non-display side. The flat screen may be adapted to substantially cover a display such that the display-side is proximate to the display. The screen may substantially let visible light pass from the display side to the non-display side. The screen may not let at least a portion (e.g., a substantial portion) of a laser beam pass from the non-display side to the display side.

### CROSS-REFERENCE TO RELATED APPLICATIONS

The present application claims the benefit of U.S. Provisional Patent Application No. 62/396,413 filed Sep. 19, 2016 and entitled “SCREEN TO PROTECT DISPLAY FROM LASER BEAM DAMAGE.” The entire content of the application is incorporated herein by reference.

### BACKGROUND

A workplace may contain different types of displays. For example, computer monitors, smartphones, tablet computers, smartwatches, laboratory equipment, televisions, etc. all have displays to present information to a user. In some cases, a display may be interactive. For example, a tablet computer might have a touch-sensitive display to let a user select or otherwise interact with graphical items on the display.

Note that some workplaces may occasionally be exposed to laser beams. For example, employees in a laboratory might turn a laser beam on while taking measurements, focusing or directing a beam, measuring an amount of energy associated with a beam, etc. It is known that a laser beam can cause damage, including permanent blindness, to the human eye. As a result, many workers wear protective glasses or goggles at the workplace. Also note, however, that a laser beam can damage a display—such as by permanently disabling pixels, portions of the display area, etc.

It would therefore be desirable to provide systems and methods to protect displays from potentially damaging laser beams.

### SUMMARY

Some embodiments are directed to a flat screen, having a display side and a non-display side, adapted to substantially cover a display such that the display-side is proximate to the display. The screen may substantially let visible light pass from the display side to the non-display side. The screen may not let at least a portion of a laser beam pass from the non-display side to the display side.

Some embodiments comprise: means for attaching a flat screen, having a display side and a non-display side, to a display such that the screen substantially covers the display such that the display-side is proximate to the display; means for operating the display, wherein the screen substantially lets visible light pass from the display side to the non-display side, and further wherein the screen does not let at least a portion of a laser beam pass from the non-display side to the display side. Some embodiments further include means for interacting with the display via a touch screen interface and/or means for detaching the screen from the display.

Some technical advantages of embodiments disclosed herein are improved systems and methods to facilitate assessments and/or predictions for a physical system in an automatic and accurate manner.

### BRIEF DESCRIPTION OF THE DRAWINGS

FIG. 1 is a high-level block diagram of a workplace in accordance with some embodiments.

FIG. 2 illustrates a protective system for a computer display according to some embodiments.

FIG. 3 illustrates a protective system for a smartphone display in accordance with some embodiments.

FIG. 4 illustrates a protective method according to some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

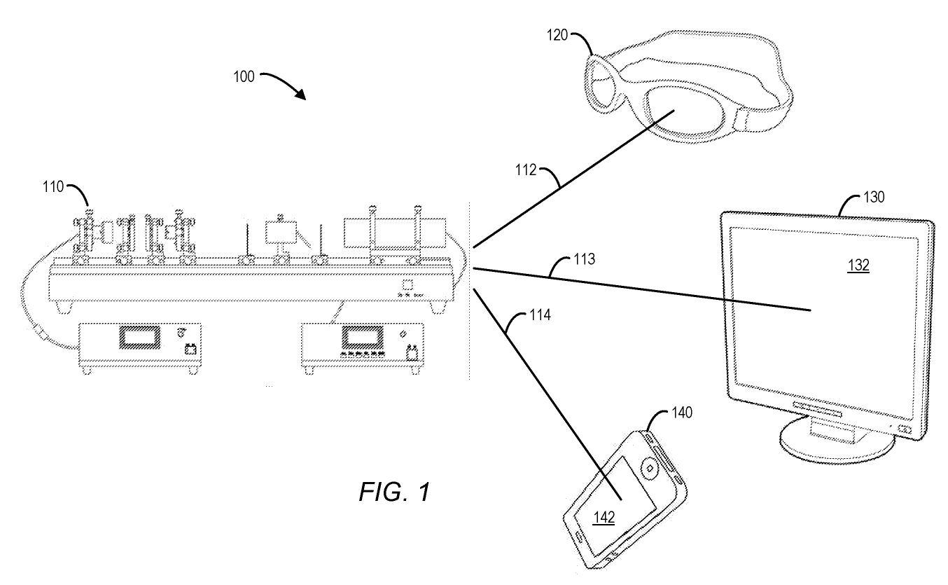

A workplace may contain different types of displays. For example, FIG. 1 is a high-level block diagram of a workplace 100 in accordance with some embodiments. Note that some workplaces 100 may occasionally be exposed to laser beams 112, 113, 114 generated by a laser 110. For example, employees in a laboratory might turn on the laser 110 while taking measurements, focusing or directing a beam, measuring an amount of energy associated with a beam, etc. It is known that a laser beam 112 can cause damage, including permanent blindness, to the human eye. As a result, many workers wear protective glasses or goggles 120 at the workplace. Also note, however, that a laser beam 113, 114 can damage a display 130, 104—such as by permanently disabling pixels, portions of the display area 132, 142, etc. Note that, computer monitors, smartphones, tablet computers, smartwatches, laboratory equipment, televisions, etc. all have displays, to present information to a user, that may be damaged by a laser beam 113, 114.

It would therefore be desirable to provide systems and methods to protect displays from potentially damaging laser beams.

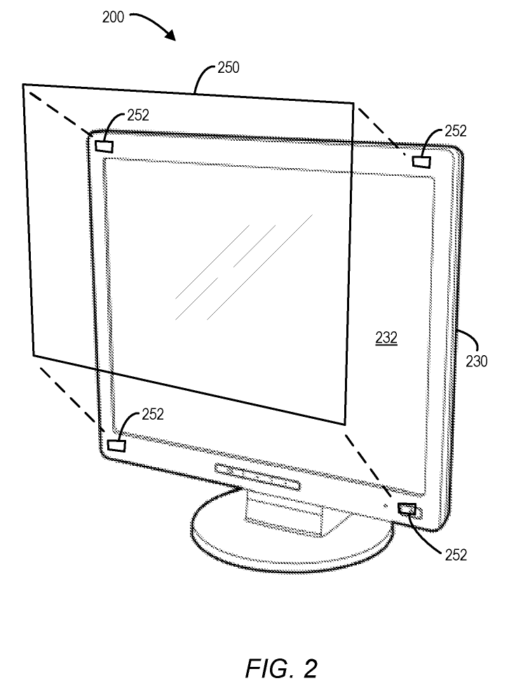

FIG. 2 illustrates a protective system 200 for a computer display 230 according to some embodiments. The computer display might be associated with, for example, a Cathode Ray Tube (“CRT”) display; a Light-Emitting Diode (“LED”); an Electro-Luminescent Display (“ELD”); an electronic paper or e-ink display; a Plasma Display Panel (“PDP”) device; a Liquid Crystal Display (“LCD”) device; a High-Performance Addressing (“HPA”) display; a Thin-Film Transistor (“TFT”) display; an Organic LED (“OLED”) display; Surface-conduction Electron-emitter Display (“SED”) device; a Field Emission Display (“FED”) device; and/or a laser television device.

According to some embodiments, a flat screen 250, such as an at least partially transparent film or cover having a display side and a non-display side, is adapted to substantially cover the display 230 (or a display portion 232 of the display 230) such that the display-side is proximate to the display 230, wherein the screen 250 substantially lets visible light pass from the display side to the non-display side. Moreover, the screen 250 does not let at least a portion of a laser beam pass from the non-display side to the display side (e.g., via reflection of the laser beam and/or absorption of the laser beam). That is, the screen 250 absorbs, reflects, or otherwise blocks the energy of the laser beam (and, as a result, may protect pixels in the display portion 232). Note that the shape of the flat screen 250 may be tailored to substantially match the display 230 (i.e., the portion of the display 230 that could potentially be damaged by a laser beam).

According to some embodiments, the screen 250 includes a plurality of attaching locations (e.g., on the display side of the screen 250 not shown in FIG. 2) adapted to be attached to corresponding attaching locations 252 of the display 230. Note that attaching locations 252 might be design so as to be repeatedly detached and re-attached. Moreover, at least one attaching location might be associated with, for example, Velcro®, a pressure mount, a suction cup, a magnet, a hook, a hinge, and/or a clasp.

In some embodiments, the screen 250 might be formed of a substance, such as plastic (e.g., extruded plastic, rolled plastic, etc.), designed to absorb or reflect a laser beam. In other embodiments, a thin coating might be applied to the screen 250, in which case the coating might be designed absorb or reflect a laser beam. Note that the screen 250 might be designed to protect the display 230 from laser beams having a certain wavelength (λₓ) or range of wavelengths (λₓ through λ_{y}) based on, for example, the particular types of lasers that might be expected to be present in the workplace. The screen 250 might be associated with a glass having absorbers within or a plastic with absorbers within.

Note that eyewear designed to protect eyes from laser beams might have, for example, an intensity absorption capability of 1,000,000 to 1. The screen 250 described herein might, for example, have a lower absorption ratio (e.g., 500:1 or 50:1) and yet still protect the display 230. In which case, a coating applied to the screen 250 might only need to be a few microns thick, tens of microns thick, etc. to protect the display 230.

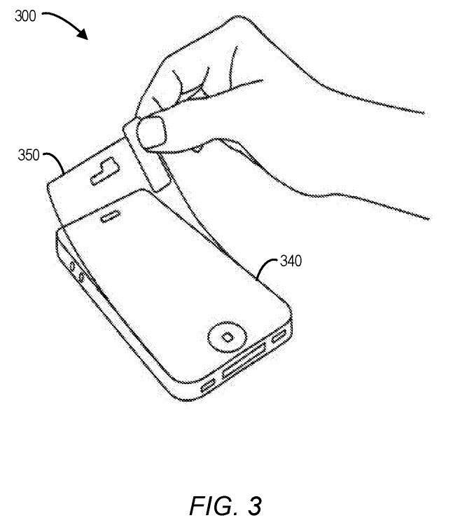

According to other embodiments, the screen 250 may “stick” to the display 230 static or an adhesive. For example, FIG. 3 illustrates a protective system 300 for a smartphone display 340 in accordance with some embodiments. As before, a flat screen 350, such as an at least partially transparent film or cover having a display side and a non-display side, is adapted to substantially cover the display 340 (or a display portion of the display 340) such that the display-side is proximate to the display 340, wherein the screen 350 substantially lets visible light pass from the display side to the non-display side. Moreover, the screen 350 does not let at least a portion of a laser beam pass from the non-display side to the display side. That is, the screen 150 absorbs, reflects, or otherwise blocks the energy of the laser beam (and, as a result, may protect pixels in the display portion).

In some cases, the display 340 may also be interactive. For example, the smartphone might have a touch-sensitive screen to let a user select or otherwise interact with graphical items on the display screen using his or her fingers. In this case, the screen 350 may be designed such that it does not prevent a user from interacting with the touch screen (e.g., the screen 250 may be thin and flexible).

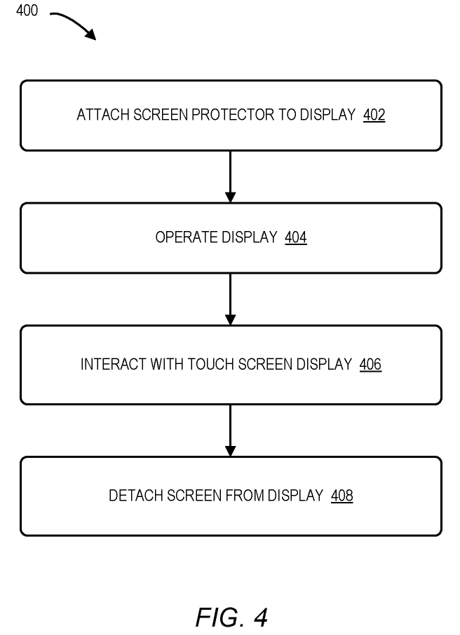

FIG. 4 illustrates a protective method 400 according to some embodiments. At 402, a user may attach a screen protector to his or her computer display. At 404, the user may operate the display (which will be protected from laser beam damage during operation). At 406, the user may interact with a touch screen display through the protective screen. At 408, the user may detach the screen (e.g., to remove the screen from the computer display when it is not needed).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A protective device, comprising:
a flat screen, having a display side and a non-display side, adapted to substantially cover a display such that the display-side is proximate to the display, wherein the screen substantially lets visible light pass from the display side to the non-display side,
and further wherein the screen does not let at least a portion of a laser beam pass from the non-display side to the display side.

2. The device of claim 1, wherein the screen does not let at least a portion of the laser beam pass from the non-display side to the display side via at least one of reflection and absorption.

3. The device of claim 1, wherein the display is associated with at least one of: a Cathode Ray Tube (“CRT”) display; a Light-Emitting Diode (“LED”); an Electro-Luminescent Display (“ELD”); an electronic paper or e-ink display; a Plasma Display Panel (“PDP”) device; a Liquid Crystal Display (“LCD”) device; a High-Performance Addressing (“HPA”) display; a Thin-Film Transistor (“TFT”) display; an Organic LED (“OLED”) display; Surface-conduction Electron-emitter Display (“SED”) device; a Field Emission Display (“FED”) device; and a laser television device.

4. The device of claim 1, wherein the display is associated with at least one of: a computer monitor, a smartphone, a tablet computer, a smartwatch, laboratory equipment, and a television.

5. The device of claim 1, wherein the display is a touch screen display and the screen does not prevent a user from interacting with the touch screen display.

6. The device of claim 1, further comprising:
one or more attaching locations, on the display side of the screen, adapted to be attached to corresponding attaching locations of the display.

7. The device of claim 1, wherein a plurality of attaching locations are provided.

8. The device of claim 7, wherein the attaching locations can be detached and re-attached.

9. The device of claim 7, wherein at least one attaching location is associated with at least one of: Velcro®; a pressure mount; a suction cup; a magnet; a hook; a hinge; and a clasp.

10. The system of claim 1, wherein the screen attaches to the display via static or an adhesive.

11. A method, comprising:
attaching a flat screen, having a display side and a non-display side, to a display such that the screen substantially covers the display such that the display-side is proximate to the display; and
operating the display, wherein the screen substantially lets visible light pass from the display side to the non-display side, and further wherein the screen does not let at least a portion of a laser beam pass from the non-display side to the display side.

12. The method of claim 11, further comprising:
interacting with the display via a touch screen interface.

13. The method of claim 11, further comprising:
detaching the screen from the display.

14. A protective device, comprising:
a substantially flat screen, having a computer display side and a non-computer display side, adapted to substantially cover a computer display such that the computer display-side is proximate to the computer display, wherein the screen substantially lets visible light pass from the computer display side to the non-computer display side,
wherein the screen does not let at least a substantial portion of a laser beam pass from the non-computer display side to the computer display side,
wherein the computer display is a computer touch screen display and the screen does not prevent a user from interacting with the computer touch screen display, and
wherein the screen attaches to the computer display via static or an adhesive.

15. The device of claim 14, wherein the screen does not let at least a portion of the laser beam pass from the non-display side to the display side via at least one of reflection and absorption.

16. The device of claim 15, wherein the computer display is associated with at least one of: a Cathode Ray Tube (“CRT”) display; a Light-Emitting Diode (“LED”); an Electro-Luminescent Display (“ELD”); an electronic paper or e-ink display; a Plasma Display Panel (“PDP”) device; a Liquid Crystal Display (“LCD”) device; a High-Performance Addressing (“HPA”) display; a Thin-Film Transistor (“TFT”) display; an Organic LED (“OLED”) display; Surface-conduction Electron-emitter Display (“SED”) device; a Field Emission Display (“FED”) device; and a laser television device.

17. The device of claim 16, wherein the computer display is associated with at least one of: a computer monitor, a smartphone, a tablet computer, a smartwatch, laboratory equipment, and a television.
